(19) United States
(12) Patent Application Publication
(10) Pub. No.: US 2017/0370477 A1
(43) Pub. Date: Dec. 28, 2017

(54) EXTERNAL CONTROL TYPE FLUID COUPLING

(71) Applicant: AISIN SEIKI KABUSHIKI KAISHA, Kariya-shi (JP)

(72) Inventors: Masao KIHARA, Okazaki-shi (JP); Shuhei YAMAZAKI, Chita-gun (JP); Kimihisa HASEBE, Okazaki-shi (JP)

(73) Assignee: AISIN SEIKI KABUSHIKI KAISHA

(21) Appl. No.: 15/625,547

(22) Filed: Jun. 16, 2017

(30) Foreign Application Priority Data
Jun. 24, 2016 (JP) 2016-125695

(51) Int. Cl. F16K 1/22; F16K 31/06

(52) U.S. Cl. CPC F16K 1/222; F16K 31/0675

(57) ABSTRACT

An external control type fluid coupling includes: a drive disk fixed to a rotary shaft; a housing rotatably supported by the rotary shaft and defining an internal space; a partition plate provided in the housing and partitioning the internal space into operation and storage chambers; a supply hole formed in the partition plate and supplying a fluid from the storage chamber to the operation chamber; a valve body provided in the housing and made of a magnetic material; and an electromagnet generating an attraction force between the electromagnet and the valve body so that the valve body is displaced to a closed state, in which the center of gravity of the valve body, rotatably connected to the housing, is set such that the valve body is rotated to a side on which the supply hole is opened by a centrifugal force acting with the rotation of the housing.

### CROSS REFERENCE TO RELATED APPLICATIONS

This application is based on and claims priority under 35 U.S.C. §119 to Japanese Patent Application 2016-125695, filed on Jun. 24, 2016, the entire contents of which are incorporated herein by reference.

### TECHNICAL FIELD

This disclosure relates to an external control type fluid coupling.

### BACKGROUND DISCUSSION

In the related art, as an external control type fluid coupling, for example, a structure described in JP2011-231896A (Reference 1) is known. The external control type fluid coupling includes a rotary shaft that is fixed to a drive disk, a housing (closed vessel) that is supported by the rotary shaft, and a partition plate that partitions an inside of the housing into an oil reservoir and a torque transmission chamber in which the drive disk is installed. Moreover, an oil supply adjusting hole is formed in the partition plate to communicate with the oil reservoir and the torque transmission chamber. In addition, the external control type fluid coupling includes a leaf spring-like valve member capable of opening and closing the oil supply adjusting hole by generating a biasing force for closing the oil supply adjusting hole, and an electromagnet that generates an attraction force for opening the oil supply adjusting hole against the biasing force of the valve member. Oil is supplied into the torque transmission chamber through the oil supply adjusting hole so that the drive disk transmits a rotation torque to the housing or an object to be driven integrally with the housing.

However, in such an external control type fluid coupling, since the electromagnet is turned on (excited) to generate the attraction force which is described above, if an abnormality occurs in the electromagnet or a power supply system, the oil supply adjusting hole cannot be opened. That is, the oil cannot be supplied through the oil supply adjusting hole and thereby the rotation torque cannot be transmitted to the housing or the object to be driven integrally with the housing.

Thus, a need exists for an external control type fluid coupling which is not susceptible to the drawback mentioned above.

### SUMMARY

An external control type fluid coupling according to an aspect of this disclosure includes a drive disk that is fixed to a rotary shaft; a housing that is rotatably supported by the rotary shaft and defines an internal space; a partition plate that is provided in the housing and partitions the internal space into an operation chamber accommodating the drive disk and a storage chamber storing a fluid; a supply hole that is formed in the partition plate and supplies the fluid from the storage chamber to the operation chamber; a valve body that is provided in the housing and is made of a magnetic material capable of opening and closing the supply hole; and an electromagnet that generates an attraction force between the electromagnet and the valve body so that the valve body is displaced to a closed state for closing the supply hole. The valve body is rotatably connected to the housing. The center of gravity of the valve body is set such that the valve body is rotated to a side on which the supply hole is opened by a centrifugal force acting with rotation of the housing.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a sectional view illustrating a structure of an external control type fluid coupling of an embodiment;

FIG. 2 is a perspective view illustrating a valve portion of the external control type fluid coupling of the same embodiment; and

FIGS. 3A and 3B are enlarged views illustrating an opening and closing operation of the external control type fluid coupling of the same embodiment.

### DETAILED DESCRIPTION

Hereinafter, an embodiment of an external control type fluid coupling will be described.

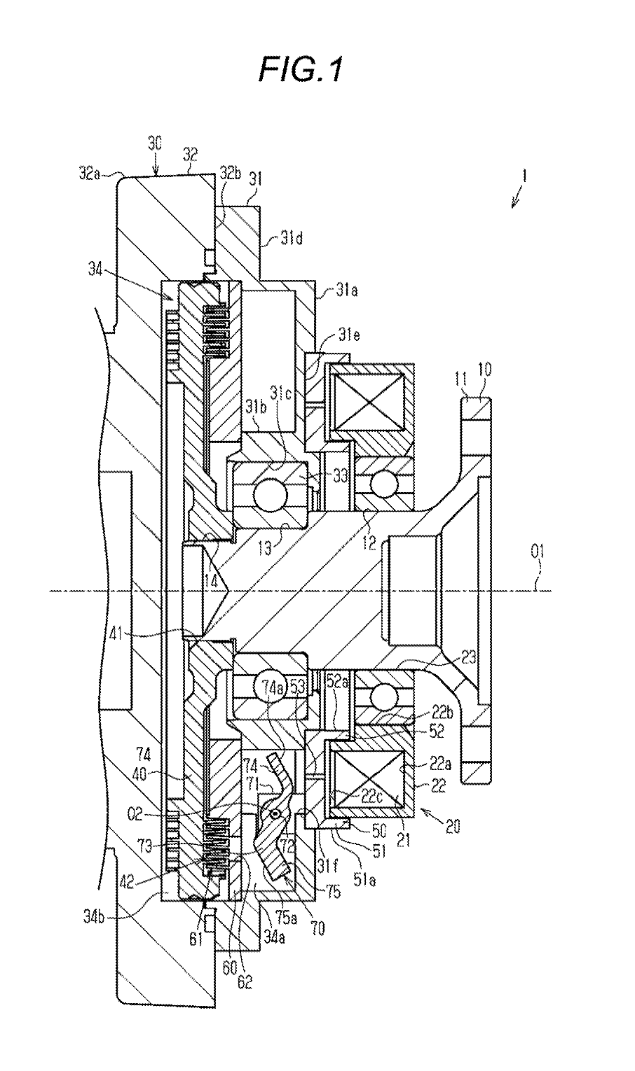

As illustrated in FIG. 1, an external control type fluid coupling 1 includes a rotary shaft 10 as a drive-side rotation body, a driving portion 20, a housing 30 as a driven-side rotation body, and a drive disk 40.

The rotary shaft 10 has a flange portion 11 protruding outward from a tip of one side thereof (right side in the drawing). A drive torque is input from an engine (not illustrated) to the flange portion 11 and thereby the rotary shaft 10 rotates around a rotation axis O1. In addition, the rotary shaft 10 has a substantially columnar large-diameter portion 12, a medium-diameter portion 13, and a small-diameter portion 14 which gradually decrease in diameter as separating from a flange portion 11 side along the rotation axis O1. Moreover, the large-diameter portion 12, the medium-diameter portion 13, and the small-diameter portion 14 are concentric with the rotation axis O1.

The driving portion 20 has a substantially ring-shaped electromagnet 21 around the rotation axis O1 and a case 22 that defines a ring groove 22a accommodating the electromagnet 21 and is made of a magnetic material. The electromagnet 21 becomes a magnetic generation source, for example, by being energized by a control signal from an external controller (not illustrated). The case 22 is rotatably supported on the large-diameter portion 12 via a first annular bearing portion 23 (bearing) fitted to an inner peripheral surface 22b, and is fixed to an engine block (not illustrated). In other words, the case 22 allows the rotation of the large-diameter portion 12 (rotary shaft 10) in a state of being fixed to the engine block.

The housing 30 has a first housing 31 and a second housing 32 which are divided into two in a direction of the rotation axis O1. The first housing 31 positioned on the flange portion 11 side (right side in the drawing) has a substantially cylindrical bottomed shape around the rotation axis O1 and has a substantially cylindrical boss portion 31b protruding around the rotation axis O1 in an inner peripheral portion of a bottom portion 31a positioned on the flange portion 11 side. The first housing 31 is rotatably supported on the medium-diameter portion 13 via a second annular bearing portion 33 (bearing) fitted to an inner peripheral surface 31c of the boss portion 31b.

On the other hand, the second housing 32 positioned on a side separating from the flange portion 11 (left side in the drawing) has a substantially cylindrical bottomed shape around the rotation axis O1 and a fan (not illustrated) for cooling the engine as an object to be driven in an outer periphery 32a.

Moreover, inner diameters of the first housing 31 and the second housing 32 are set to be equal to each other in size, and a substantially annular outward flange portion 31d formed on an outer peripheral portion of the first housing 31 and an opening end 32b of the second housing 32 are in close contact with each other, and liquid-tightly coupled to each other, thereby forming an internal space 34. A viscose fluid (not illustrated) such as silicone oil is stored in the internal space 34. The first housing 31 and the second housing 32 (fan) integrally rotate around the medium-diameter portion 13.

Here, a substantially annular peripheral groove 31e around the rotation axis O1 is formed in the bottom portion 31a of the first housing 31 to be recessed toward a side (left side in the drawing) separating from the flange portion 11. The peripheral groove 31e faces the case 22 (driving portion 20) in the direction of the rotation axis O1. In addition, a through hole 31f is formed in the bottom portion 31a of the first housing 31 to penetrate substantially parallel to the rotation axis O1 in conformity with a predetermined angular position (angular position on a lower side of the drawing) of the peripheral groove 31e.

Therefore, a yoke 50 made of a magnetic material formed in conformity with the peripheral groove 31e is attached to the peripheral groove 31e of the first housing 31 (bottom portion 31a). That is, the yoke 50 has a substantially annular outer yoke 51 having an outer diameter equal to an inner diameter of the peripheral groove 31e in size on an outer peripheral side and fixed to the peripheral groove 31e, and a substantially annular inner yoke 52 having an inner diameter equal to the inner diameter of the peripheral groove 31e in size on an inner peripheral side and fixed to the peripheral groove 31e. Moreover, the inner diameter of the outer yoke 51 is set greater than the outer diameter of an inner yoke 52 in size, and a gap 53 is set between the outer yoke 51 and the inner yoke 52 in the radial direction. A sealing unit made of an appropriate non-magnetic material is provided in the gap 53 and the outer yoke 51 and the inner yoke 52 are cooperated with each other to close the through hole 31f of the first housing 31 (bottom portion 31a).

The outer yoke 51 and the inner yoke 52 face the case 22 (driving portion 20) in the direction of the rotation axis O1, and respectively have substantially cylindrical outer side wall 51a and inner side wall 52a standing upright along the outer peripheral surface and the inner peripheral surface of the case 22. Therefore, the outer yoke 51 and the inner yoke 52 (yoke 50) close an opening 22c in a state where the case 22 is interposed between the outer side wall 51a and the inner side wall 52a.

A substantially donut-plate-shaped partition plate 60 is provided at an opening end portion of the first housing 31 so as to divide the internal space 34 formed between the first housing 31 and the second housing 32 into two in the direction of the rotation axis O1. Therefore, the internal space 34 defines a storage chamber 34a and an operation chamber 34b respectively on the yoke 50 side and the second housing 32 side with the partition plate 60 interposed therebetween. Moreover, a recovery path (not illustrated) is formed in the first housing 31 to communicate with the storage chamber 34a and the operation chamber 34b.

A first labyrinth portion 61 having a substantially comb-shaped cross section is formed at the outer peripheral portion of the partition plate 60 on the operation chamber 34b side, and a supply hole 62 penetrating the partition plate 60 substantially parallel to the direction of the rotation axis O1 is formed at the predetermined angular position (angular position on the lower side of the drawing). The supply hole 62 communicates with the storage chamber 34a and the operation chamber 34b.

The substantially donut-plate-shaped drive disk 40 disposed on the operation chamber 34b side is connected to the small-diameter portion 14 of the rotary shaft 10 so as to be integrally rotated. That is, an inner peripheral portion 41 of the drive disk 40 is engaged with the small-diameter portion 14 of the rotary shaft 10 so that the drive disk 40 is integrally rotated with the rotary shaft 10.

A second labyrinth portion 42 is formed at an outer peripheral portion of the drive disk 40 facing the first labyrinth portion 61 in the direction of the rotation axis O1. The second labyrinth portion 42 has a substantially comb-shaped cross section so as to protrude alternately with the first labyrinth portion 61. The first labyrinth portion 61 and the second labyrinth portion 42 cooperate to constitute a torque transmission portion.

A valve portion 70 is provided at the predetermined angular position (angular position on the lower side of the drawing) within the operation chamber 34b in the first housing 31.

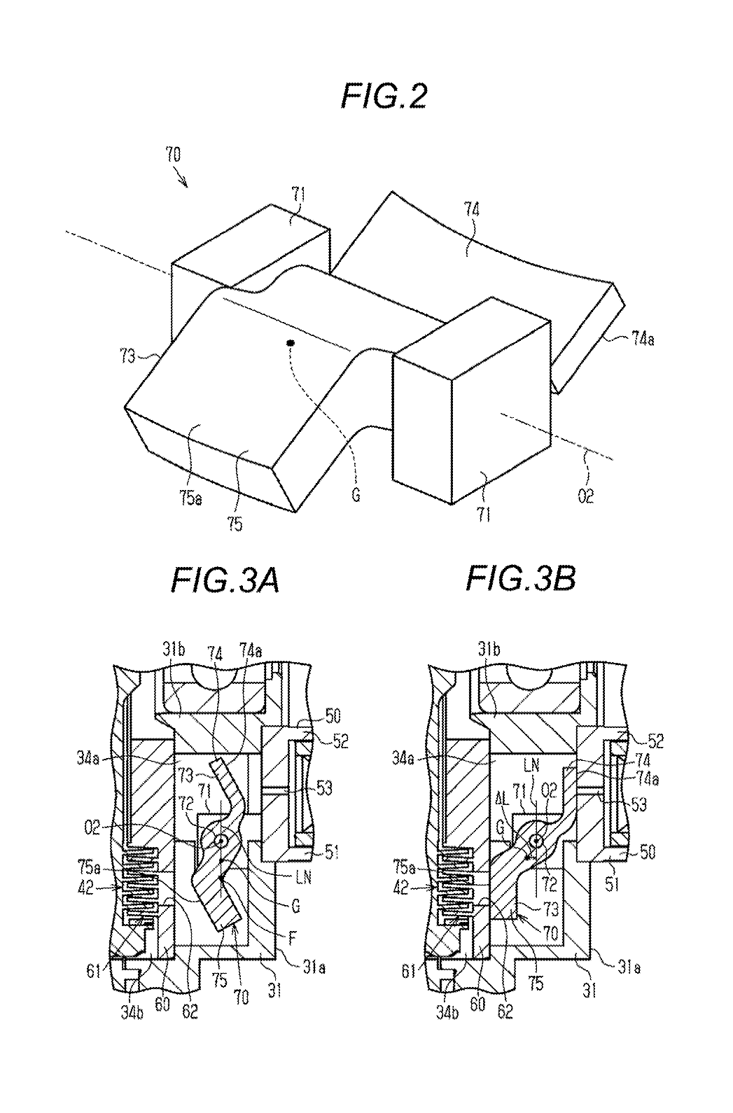

That is, as also illustrated in FIG. 2, the valve portion 70 has a pair of block-shaped support portions 71 standing upright parallel to each other from the bottom portion 31a of the first housing 31 substantially parallel to the rotation axis O1 with a space in a tangential direction in the peripheral direction around the rotation axis O1. In addition, the valve portion 70 has a substantially columnar shaft portion 72 which is an axis (hereinafter, referred to as “rotation axis O2”) extending in the tangential direction, and a substantially S-shaped valve body 73 made of a magnetic material. The both support portions 71 unrotatably support both ends of the shaft portion 72. The shaft portion 72 passes through a center portion of the valve body 73 and rotatably supports the valve body 73. Therefore, the valve body 73 rotates around the rotation axis O2.

The valve body 73 has an electromagnet-side valve body portion 74 and a supply hole-side valve body portion 75 on an inner side and an outer side of the shaft portion 72 in the radial direction around the rotation axis O1. The supply hole-side valve body portion 75 is set to have a plate thickness greater than that of the electromagnet-side valve body portion 74 and has a mass greater than that of the electromagnet-side valve body portion 74. That is, the center of gravity G of the valve body 73 is positioned on the supply hole-side valve body portion 75 side, that is, outside the rotation axis O2 of the shaft portion 72 in the radial direction around the rotation axis O1. In addition, facing planar portions 74a and 75a where the yoke 50 (gap 53) and the partition plate 60 (supply hole 62) face on a rotation locus around the rotation axis O2 are respectively formed in the electromagnet-side valve body portion 74 and the supply hole-side valve body portion 75.

Here, as illustrated in FIG. 3A, the valve body 73 is configured such that when the rotation axis O2 and the center of gravity G are in a state of being aligned in a straight line (on a straight line LN) in the radial direction (vertical direction in the drawing) around the rotation axis O1, the facing planar portions 74a and 75a are respectively separated from the yoke 50 and the partition plate 60. On the other hand, the valve body 73 is configured such that when the facing planar portion 75a is in a state of abutting against the partition plate 60 (peripheral portion of the supply hole 62), the facing planar portion 74a abuts against or approaches the yoke 50.

Next, an operation of the external control type fluid coupling of the embodiment will be described.

As illustrated in FIGS. 3A and 3B, in the external control type fluid coupling 1, for example, the drive torque is input from the engine (not illustrated) so that the drive disk 40 rotates around the rotation axis O1 together with the rotary shaft 10. In this case, when the supply hole 62 is opened, a fluid within the storage chamber 34a flows into the operation chamber 34b (torque transmission portion) via the supply hole 62 so that the drive disk 40 transmits the rotation torque to the partition plate 60 utilizing the viscosity of the fluid. Therefore, the first housing 31 (and the second housing 32) rotates integrally with the partition plate 60 and the fan rotates. The external control type fluid coupling 1 controls the rotation of the fan by switching opening and closing states of the supply hole 62 by the valve portion 70. Moreover, even in a state where the fluid is not present in the operation chamber 34b of the internal space 34, the rotation torque of the drive disk 40 is slightly transmitted to the housing 30. Therefore, when the drive disk 40 rotates, the housing 30 also rotates accordingly.

The valve body 73 switches between an open state in which the supply hole 62 of the partition plate 60 is opened and a closed state in which the supply hole 62 is closed. Therefore, the valve portion 70 supplies the fluid within the storage chamber 34a to the operation chamber 34b or cuts off the supply thereof.

Since the valve body 73 is provided in the housing 30 (second housing 32), a centrifugal force F generated around the rotation axis O1 acts and the valve body 73 separates from the partition plate 60 so that the valve body 73 is in the open state. Specifically, the center of gravity G thereof is displaced so as to be positioned on the straight line LN. Therefore, the supply hole-side valve body portion 75 of the valve body 73 is separated from the partition plate 60.

In addition, an attraction force (magnetic force) generated by energization of the electromagnet 21 by a control signal from an external controller acts to cover a peripheral edge portion of the supply hole 62 so that the valve body 73 is in the closed state. Specifically, the electromagnet-side valve body portion 74 of the valve body 73 of the magnetic material is attracted to the electromagnet 21 side so that the supply hole-side valve body portion 75 approaches the partition plate 60 (peripheral edge portion of the supply hole 62). Therefore, the facing planar portion 75a abuts against the partition plate 60 (peripheral edge portion of the supply hole 62) and the valve body 73 is in the closed state in which the facing planar portion 74a abuts against or approaches the yoke 50. That is, the electromagnet 21 generates a sufficient attraction force to close the valve body 73 against the centrifugal force F.

As described above, according to the embodiment, the following effects can be obtained.

(1) In the embodiment, the valve body 73 is rotated toward a side where the supply hole 62 is opened by the centrifugal force F acting with the rotation of the housing 30 when the electromagnet 21 is in a non-energized state. Accordingly, the fluid is supplied from the storage chamber 34a to the operation chamber 34b so that the rotation torque of the drive disk 40 is transmitted to the housing 30 or the fan integrated with the housing 30. Therefore, for example, even in a case where an abnormality occurs in the electromagnet 21 or the power supply system thereof, the rotation torque of the drive disk 40 can be transmitted to the housing 30 or the fan integrated with the housing 30.

(2) As illustrated in FIGS. 3A and 3B, when the valve body 73 is in the closed state, the valve body 73 is separated from the straight line LN extending in the radial direction passing through the shaft portion 72 of the valve body 73 by a predetermined distance ΔL and is set so as to reduce the distance separating from the straight line LN in accordance with the rotation on the side where the supply hole 62 is opened. Therefore, in the embodiment, when the valve body 73 is in the closed state, the distance of the center of gravity G separating from the straight line LN is maximum (predetermined distance ΔL). That is, since an accommodation space required for the valve body 73 may be secured based on a rotation range that permits the movement of the center of gravity G up to the predetermined distance ΔL, it is possible to suppress an increase of the accommodation space in size.

(3) In the embodiment, the electromagnet-side valve body portion 74, the rotation axis O2 of the valve body 73, and the supply hole-side valve body portion 75 are formed so as to be disposed in this order in a radial outward direction around the rotation axis O1 of the rotary shaft 10. Therefore, the electromagnet-side valve body portion 74 is disposed closer to the radial inward than the rotation axis O2 of the valve body 73. That is, the electromagnet 21 attracts the electromagnet-side valve body portion 74 positioned on the relatively inner peripheral side of the valve body 73. Therefore, the dimension in the radial direction of the electromagnet 21 can be reduced and it is possible to suppress an increase thereof in size.

(4) In the embodiment, in the valve body 73, the center of gravity G is disposed outside the shaft portion 72 in the radial direction around the rotation axis O1 by changing the plate thicknesses of the supply hole-side valve body portion 75 and the electromagnet-side valve body portion 74. Therefore, it is possible to reduce the dimension of the electromagnet-side valve body portion 74 in the longitudinal direction, for example, compared to a case where the plate thicknesses of the supply hole-side valve body portion 75 and the electromagnet-side valve body portion 74 are equal to each other. Thus, it is possible to suppress expansion of an occupied space required for the rotation of the valve body 73.

Moreover, the embodiment described above may be modified as follows.
In the embodiment, two or more sets of the valve portion 70 and the supply hole 62 may be provided.
In the embodiment, the first labyrinth portion 61 is provided in the second housing 32 and the second labyrinth portion 42 may be provided on a side facing the second housing 32. That is, the drive disk 40 and the second housing 32 may cooperate to constitute the torque transmission portion.
In the embodiment, the yoke 50 may be fixed to the case 22. In this case, it is preferable to form a non-penetrating hole shape instead of the through hole 31f of the first housing 31.
In the embodiment, the supply hole 62 may be opened by energizing the electromagnet 21. That is, for example, in the valve portion, the electromagnet-side valve body portion of the valve body is formed by a permanent magnet. Therefore, when the electromagnet 21 is deenergized, the electromagnet-side valve body portion and the yoke 50 abuts against or approaches each other so that the closed state may be established, and when the electromagnet 21 is energized, the electromagnet-side valve body portion and the electromagnet 21 repel each other so that the open state may be established. Even if the rotational speed of the housing 30 is low and the centrifugal force F is small, the valve body 73 can be brought into the open state in cooperation with the centrifugal force F and the rotational speed of the housing 30 can be increased more rapidly.
In the embodiment, the plate thickness of the supply hole-side valve body portion 75 may be set equal to or less than the plate thickness of the electromagnet-side valve body portion 74. That is, the mass may be changed by changing the width dimension or the longitudinal dimension of the supply hole-side valve body portion 75 and the electromagnet-side valve body portion 74.
In the embodiment, a sealing member having a sealing property may be provided on the facing planar portion 75a of the supply hole-side valve body portion 75.
In the embodiment, a biasing member having a biasing force for holding the valve body 73 in the closed state may be provided. In this case, the attraction force of the electromagnet 21 required to bring the valve body 73 into the closed state can be reduced and it is possible to decrease the electromagnet 21 in size.

An external control type fluid coupling according to an aspect of this disclosure includes a drive disk that is fixed to a rotary shaft; a housing that is rotatably supported by the rotary shaft and defines an internal space; a partition plate that is provided in the housing and partitions the internal space into an operation chamber accommodating the drive disk and a storage chamber storing a fluid; a supply hole that is formed in the partition plate and supplies the fluid from the storage chamber to the operation chamber; a valve body that is provided in the housing and is made of a magnetic material capable of opening and closing the supply hole; and an electromagnet that generates an attraction force between the electromagnet and the valve body so that the valve body is displaced to a closed state for closing the supply hole. The valve body is rotatably connected to the housing. The center of gravity of the valve body is set such that the valve body is rotated to a side on which the supply hole is opened by a centrifugal force acting with rotation of the housing.

According to this configuration, the valve body is rotated to a side on which the supply hole is opened by the centrifugal force acting with the rotation of the housing when the electromagnet is in a non-energized state. Accordingly, the fluid is supplied from the storage chamber to the operation chamber and thereby the rotation torque of the drive disk is transmitted to the housing or an object to be driven integrally with the housing. Therefore, for example, even in a case where an abnormality occurs in the electromagnet or a power supply system thereof, the rotation torque of the drive disk can be transmitted to the housing or the object to be driven integrally with the housing.

In the external control type fluid coupling, it is preferable that the center of gravity is positioned closer to an outside than a shaft of the valve body in a radial direction around an axis of the rotary shaft, is separated from a straight line extending in the radial direction through the shaft of the valve body by a predetermined distance when the valve body is in the closed state, and is set so as to reduce a distance separating from the straight line in accordance with the rotation of the valve body to a side on which the supply hole is opened.

According to this configuration, the distance of the center of gravity separating from the straight line is the maximum (predetermined distance described above) when the valve body is in the closed state. That is, since an accommodation space required for the valve body may be secured based on a rotation range allowing movement of the center of gravity up to the predetermined distance, it is possible to suppress an increase in size of the accommodation space.

In the external control type fluid coupling, it is preferable that the electromagnet is provided so as to pass through the rotary shaft, the valve body has a supply hole-side valve body portion that closes the supply hole and an electromagnet-side valve body portion that is attracted to the electromagnet when in the closed state, and the valve body is formed so that the electromagnet-side valve body portion, an axis of the valve body, and the supply hole-side valve body portion are disposed in this order in a radial outward direction around the axis of the rotary shaft.

According to this configuration, the electromagnet-side valve body portion is disposed closer to the radial inward than the axis of the valve body. That is, the electromagnet attracts the electromagnet-side valve body portion positioned on a relatively inner peripheral side of the valve body. Therefore, it is possible to reduce a dimension of the electromagnet in the radial direction and to suppress an increase in size thereof.

According to the aspect of this disclosure, even in a case where an abnormality occurs in the electromagnet or a power supply system, the rotation torque can be transmitted to the housing or the object to be driven integrally with the housing.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An external control type fluid coupling comprising:
a drive disk that is fixed to a rotary shaft;
a housing that is rotatably supported by the rotary shaft and defines an internal space;
a partition plate that is provided in the housing and partitions the internal space into an operation chamber accommodating the drive disk and a storage chamber storing a fluid;
a supply hole that is formed in the partition plate and supplies the fluid from the storage chamber to the operation chamber;
a valve body that is provided in the housing and is made of a magnetic material capable of opening and closing the supply hole; and
an electromagnet that generates an attraction force between the electromagnet and the valve body so that the valve body is displaced to a closed state for closing the supply hole,
wherein the valve body is rotatably connected to the housing, and
the center of gravity of the valve body is set such that the valve body is rotated to a side on which the supply hole is opened by a centrifugal force acting with the rotation of the housing.

2. The external control type fluid coupling according to claim 1,
wherein the center of gravity is positioned closer to an outside than a shaft of the valve body in a radial direction around an axis of the rotary shaft, is separated from a straight line extending in the radial direction through the shaft of the valve body by a predetermined distance when the valve body is in the closed state, and is set so as to reduce a distance separating from the straight line in accordance with the rotation of the valve body to a side on which the supply hole is opened.

3. The external control type fluid coupling according to claim 1,
wherein the electromagnet is provided so as to pass through the rotary shaft,
the valve body has a supply hole-side valve body portion that closes the supply hole and an electromagnet-side valve body portion that is attracted to the electromagnet when in the closed state, and
the valve body is formed so that the electromagnet-side valve body portion, an axis of the valve body, and the supply hole-side valve body portion are disposed in this order in a radial outward direction around the axis of the rotary shaft.

4. The external control type fluid coupling according to claim 2,
wherein the electromagnet is provided so as to pass through the rotary shaft,
the valve body has a supply hole-side valve body portion that closes the supply hole and an electromagnet-side valve body portion that is attracted to the electromagnet when in the closed state, and
the valve body is formed so that the electromagnet-side valve body portion, an axis of the valve body, and the supply hole-side valve body portion are disposed in this order in a radial outward direction around the axis of the rotary shaft.
